(19) United States
(12) Patent Application Publication
(10) Pub. No.: US 2009/0175047 A1
(43) Pub. Date: Jul. 9, 2009

(54) AUXILIARY LUMINOUS TRIM STRIP OF A CAR LAMP

(75) Inventor: Lin-Mei TSAI, Taichung City (TW)

Correspondence Address: EGBERT LAW OFFICES, 412 MAIN STREET, 7TH FLOOR, HOUSTON, TX, 77002, US

(73) Assignee: KENG LIEN INDUSTRIAL Co., Ltd., Taichung City (TW)

(21) Appl. No.: 11/969,909

(22) Filed: Jan. 6, 2008

(51) Int. Cl. B60Q 1/00; F21V 7/00; F21V 11/00

(52) U.S. Cl. 362/487; 362/341; 362/351

(57) ABSTRACT

The present invention provides an auxiliary luminous trim strip of a car lamp. The trim strip has a long strip body, a car lamp mating surface mating with the surface of the car lamp, a light-emitting surface, placed in front of the strip body, a locating component, used to locate the strip body and car lamp, a plurality of luminous bodies, assembled onto the light-emitting surface in a predefined configuration, and a power supply portion, used to supply power required for the luminous bodies. The luminous trim strip generates a trimming effect by the color, texture and shape of the strip body and enhances illumination intensity through the light emission of the luminous bodies, further enhancing the warning effect of the car lamp.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fitting of a car lamp, and more particularly to an innovative fitting with a luminous trim strip.

2. Description of Related Art Including Information Disclosed Under 37 CFR 1.97 and 37 CFR 1.98

Poor visibility at nighttime is one of the contributing factors to traffic accidents. In spite of the fact that multidirectional light emission is considered in the lighting structure of cars and locomotives, the headlamp and rear lamp are still generally designed in such a manner that their lateral extension only enables oncoming cars and pedestrians to identify the car itself and its edge for warning purposes. The direction of light emission for headlamp and rear lamp is concentrated on front and rear sides, so the lateral emission effect is rather weak, especially during rainy and foggy weather.

An auxiliary car lamp attached laterally to the car body has been developed, as illustrated in Taiwan patent No. 089213475, entitled “Auxiliary Indicator of Cars and Locomotives”, which gives warning by a light-emitting structure attached around the car body. However, a number of luminous bodies are required and leads to great energy consumption. Also, the rays of lamps projected laterally will likely generate glaring light, affecting the oncoming cars or pedestrians. Moreover, the appearance will impair aesthetics.

To improve the aesthetic property of a car lamp, a patch is attached around the car lamp forming a frame-or strip-like trimming effect. Such a patch brings about optical shielding and reduces the lighting effect of car lamp, so it is not an ideal solution.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The luminous trim strip of the present invention generates a trimming effect by the color, texture and shape of the strip body and enhances illumination intensity through the light emission of a luminous body, further enhancing the warning effects of car lamp. So, the luminous trim strip provides an improved lighting, alarming and aesthetic property for the car lamp.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the luminous trim strip and car lamp of the present invention.

FIG. 2 shows an assembled perspective view of the luminous trim strip and car lamp of the present invention.

FIG. 3 shows a front elevation view of the luminous trim strip of the present invention.

FIG. 4 shows a sectional view of the preferred embodiment of the light reflecting layer of the present invention.

FIG. 5 shows another sectional view of another preferred embodiment of the light reflecting layer of the present invention.

FIG. 6 shows another sectional view of a configuration of the luminous body and light reflecting layer of the present invention.

FIG. 7 shows a perspective view of the luminous trim strip and car lamp of the present invention on a car.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

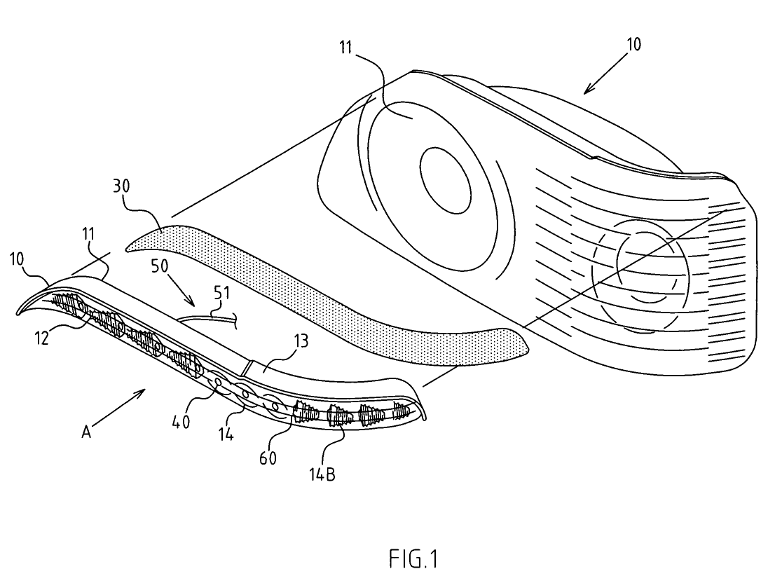

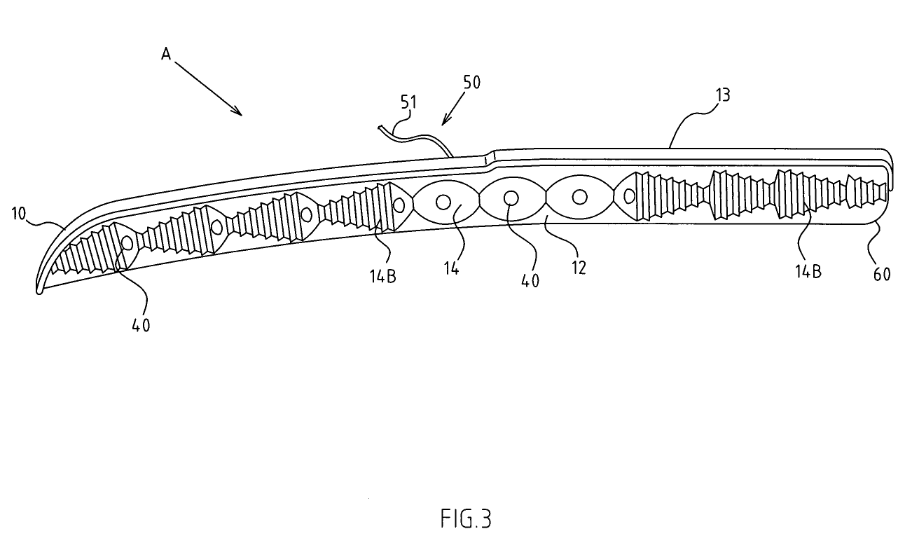

FIGS. 1-3 depict preferred embodiments of the auxiliary luminous trim strip of a car lamp of the present invention. The embodiments are provided only for explanatory purposes with respect to the patent claims.

The luminous trim strip A is specifically attached onto the surface 21 of existing car lamp 20 for lighting, alarming and trimming purposes. The luminous trim strip A is provided with a strip body 10, which is designed into a long strip of predefined thickness.

The strip body 10 comprises a car lamp mating surface 11, which is for mating with the surface 21 of existing car lamp 20. The car lamps currently available are generally designed with a curved face; therefore, the car lamp mating surface 11 can have a curved face accordingly.

A light-emitting surface 12 is placed on front of the strip body 10.

A locating component 30 is used to locate the strip body 10 and car lamp 20. The locating component 30 of the preferred embodiment is a double-sided adhesive tape, which is adhered to the car lamp mating surface 11 of the strip body 10, so that the strip body 10 could be fixed securely on the surface 21 of the car lamp 20.

A plurality of luminous bodies 40 are assembled onto the light-emitting surface 12 of the strip body 10 in a predefined configuration. The luminous bodies 40 are light-emitting diodes (LEDs).

A power supply portion 50 is used to supply power required for the luminous bodies 40. The power supply portion 50 of the preferred embodiment is a conductive circuit 51, which is connected with the electric line of the car lamp 20. The luminous bodies 40 of the luminous trim strip A are highlighted simultaneously with the car lamp 20. Alternatively, the conductive circuit 51 can be connected with the electrical lines of other lamps (e.g. direction indicator, brake lamp and alarm indicator) on the vehicle for simultaneous highlighting of the lamps. Furthermore, the lighting modes (e.g. flashing, chasing or twinkling modes) of said luminous bodies 40 could be controlled using present lighting circuit technology for flexible change of the light-emitting state of the luminous bodies 40.

The strip body 10 has a fixed curvature matching the predefined surface curvature of the car lamp 20. Alternatively, the strip body 10 can also be flexibly adjusted in line with the surface curvature of the car lamp, so that the strip body 10 can be easily adhered onto the surface of car lamp 20 for reliable fixation.

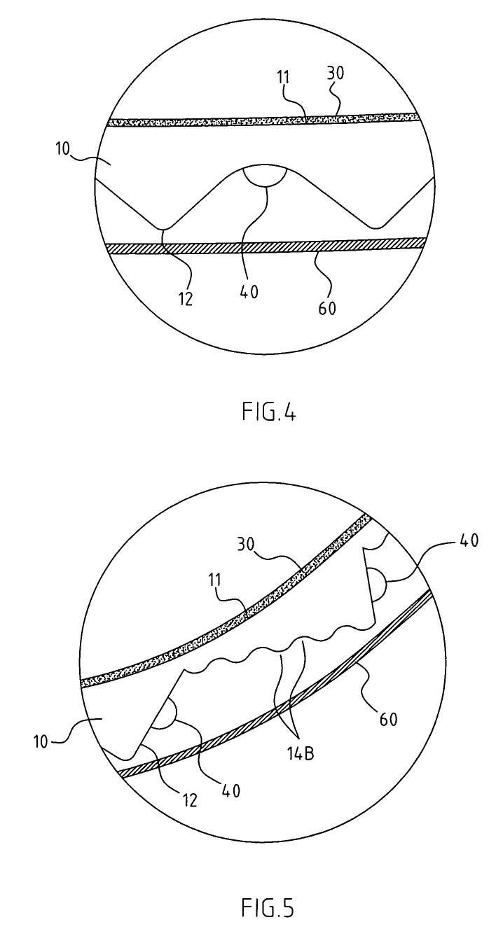

The light-emitting surface 12 of the strip body 10 is provided with a light reflecting layer 14 corresponding to the luminous bodies 40, thereby diffusing the rays of the luminous bodies 40. The light reflecting layer 14 can have many shapes, e.g. curved shape (e.g. FIG. 4) or corrugated shape (e.g. the light reflecting layer 14B in FIG. 5).

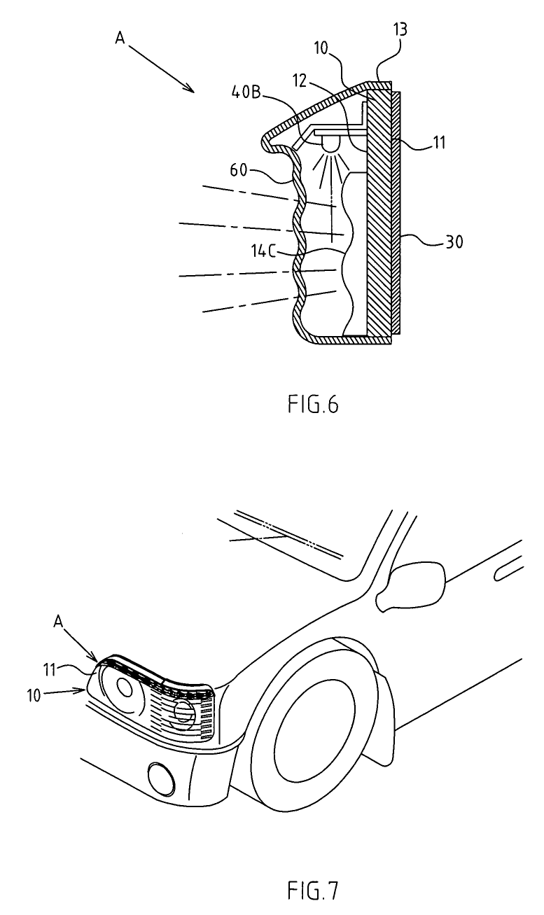

FIG. 6 depicts the preferred embodiment of another configuration of the luminous body and light reflecting layer. The luminous bodies 40B are assembled onto the upper part of the light-emitting surface 12 for downward emission, while a corrugated light reflecting layer 14C is placed at the lower part of the light-emitting surface 12, so that the light of the luminous bodies 40B is emitted towards the protecting cover 60 via the light reflecting layer 14C.

A protecting cover 60 is externally arranged onto the light-emitting surface of the strip body 10. The protecting cover 60 is made of transparent materials and is useful for light transmission of luminous bodies 40. The protecting cover 60 provides a protective shield for the luminous bodies 40 and forms a refraction line to further diffuse the light of luminous bodies 40 for uniform light emission.

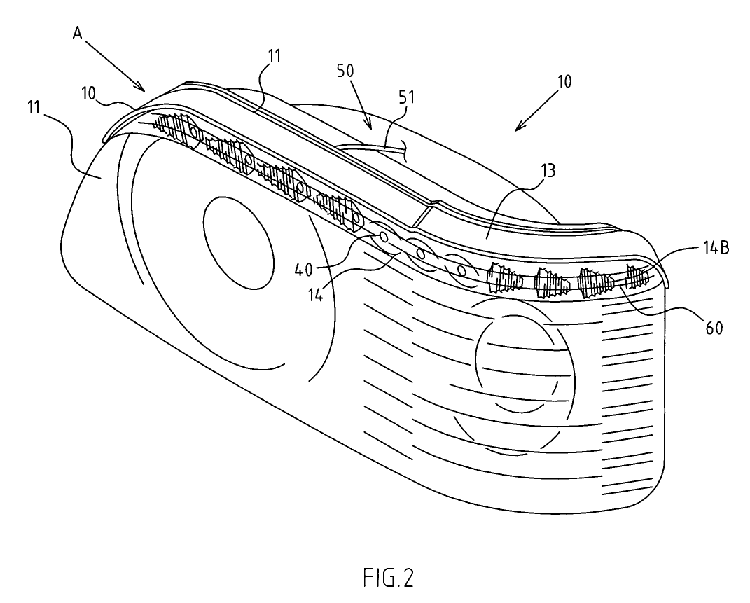

Referring to FIG. 2, a lateral portion 13 of the strip body 10 is shaped the same as the exterior of the car lamp 20 or shaped unlike the exterior of the car lamp 20, e.g. concave/convex or flexible pattern.

Based upon above-specified structures, the present invention is operated as follows:

Referring to FIGS. 1 and 2, when the luminous trim strip A is coupled with the existing car lamp 20, the locating component 30 enables the strip body 10 of luminous trim strip A to be securely mated with the surface 21 of the car lamp 20. The conductive circuit 51 of the power supply portion 50 is connected with the electrical line of the car lamp 20 for the installation of luminous trim strip A. FIG. 7 depicts the combination of luminous trim strip A and car lamp 20 on a car. When the luminous trim strip A is not activated, the car lamp is decorated by the color, texture and shape of the luminous trim strip A. When the luminous trim strip A is activated, the intensity of forward and backward rays of car lamp 20 are enhanced, and the brightness of lateral rays is improved for a better warning effect.

1-7. (canceled)

8. A light-emitting device for use with a lamp of a vehicle, the light-emitting device comprising:
an elongated body having a mating surface and an interior, said mating surface having a configuration suitable for mating with a surface of the lamp;
a light-reflective surface affixed in said interior of said elongated body;
a protective cover affixed on said elongated body, said protective cover being generally transparent or translucent;
a locating means affixed to said mating surface for affixing said elongated body to the lamp;
a plurality of luminous bodies affixed to said interior of said elongated body, said plurality of luminous bodies extending in spaced relation along a generally horizontal orientation so as to direct light therefrom downwardly toward said light-reflective surface; and
a power supplying means connected to said plurality of luminous bodies, said power supplying means providing power to said plurality of luminous bodies.

9. The light-emitting device of claim 8, said elongated body being flexible.

10. The light-emitting device of claim 8, said locating means being a double-sided adhesive tape adhered on one side of said mating surface.

11. The light-emitting device of claim 8, said light-reflective surface being of a corrugated shape so as to diffuse light from said plurality of luminous bodies, said light-reflective surface extending in a generally vertical orientation.

12. The light-emitting device of claim 8, said power-supplying means comprising a conductive circuit, said conductive circuit suitable for connection to an electric line extending to the car lamp.
